(19) United States
(12) Patent Application Publication
(10) Pub. No.: US 2013/0339136 A1
(43) Pub. Date: Dec. 19, 2013

(54) DETECTION OF EVENTS FROM BURSTS OF ACTIVITY INDICATORS

(71) Applicants: Nishith Parikh, Fremont, CA (US); Neelakantan Sundaresan, Mountain View, CA (US)

(72) Inventors: Nishith Parikh, Fremont, CA (US); Neelakantan Sundaresan, Mountain View, CA (US)

(73) Assignee: eBay Inc., San Jose, CA (US)

(21) Appl. No.: 13/525,966

(22) Filed: Jun. 18, 2012

(51) Int. Cl. G06F 17/30; G06Q 30/02; G06F 7/00

(52) U.S. Cl. 705/14.49; 707/803; 707/E17.014; 707/E17.032

(57) ABSTRACT

An event detection machine may access time-stamped activity indicators from a database, and the event detection machine may determine that a first burst of activity indicators is repetitive of a second burst of activity indicators. Such a determination may be based on the first and second bursts each including a keyword that is shared in common between the first and second bursts. The event detection machine may determine that these bursts of activity indicators is representative of a repetitive event that is characterized by the keyword shared in common among the bursts of activity indicators. Based on such a determination, the event detection machine may generate or modify a data structure that indicates a time period as encompassing the repetitive event that corresponds to the keyword shared in common between the first and second bursts of activity indicators.

### TECHNICAL FIELD

The subject matter disclosed herein generally relates to the processing of data. Specifically, the present disclosure addresses systems and methods that facilitate detection of events from bursts of activity indicators.

### BACKGROUND

A machine may provide one or more network-based services to one or more users of the machine or those networked-based services. For example, a server machine may form all or part of a network-based system that allows a user to perform one or more activities with respect to the network-based system. As another example, a group of networked machines may form all or part of a network-based system configured to provide one or more cloud computing services. Such a group of networked machines need not be located in the same geographical location (e.g., in one city or country) but rather may be scattered among multiple geographical locations (e.g., multiple cities or countries). Examples of network-based systems include commerce systems (e.g., shopping websites), publication systems (e.g., classified advertisement websites), listing systems (e.g., auction websites), and transaction systems (e.g., payment websites). Examples of activities that may be performed include information requests (e.g., queries for search results, requests for recommendations, views of a webpage, or downloads of content, such as documents, media, or files), publications (e.g., feedback, ratings, reviews, comments, blog posts, submissions, messages, or articles), and transactional activities (e.g., purchases, sales, bids, or offers).

### BRIEF DESCRIPTION OF THE DRAWINGS

Some embodiments are illustrated by way of example and not limitation in the figures of the accompanying drawings.

FIG. 1 is a network diagram illustrating a network environment suitable for detection of events from bursts of activity indicators, according to some example embodiments.

FIG. 2 is a conceptual diagram illustrating numbers of activity indicators detected over time, according to some example embodiments.

FIG. 3 is a block diagram illustrating components of an event detection machine, according to some example embodiments.

FIG. 4-6 are flowcharts illustrating operations of the event detection machine in performing a method of detecting events from bursts of activity indicators, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to detection of events from bursts of activity indicators. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

An event detection machine (e.g., a computer system configured by special-purpose software) may monitor and detect activity indicators for one or more services provided by network-based system. An activity indicator is a body of information (e.g., data) received, accessed, or otherwise detected by the event detection machine, or the activity indicator indicates that an activity has been initiated, performed, or completed (e.g., by a user) with respect to a service. For example, if a user performs a search, the event detection machine may detect a query (e.g., one or more search criteria) being submitted to the network-based system. As another example, if the user makes a purchase, the event detection machine may detect a transaction (e.g., a purchase order or a payment) being authorized for processing by the network-based system. As yet another example, if the user lists an item or product for sale, the event detection machine may detect a submission of a listing to the network-based system or a publication of the listing by the network-based system. As a further example, if the user requests information about a product, the event detection machine may detect the request (e.g., for a document or webpage describing the product) being submitted to the network-based system. As a still further example, if the user submits a rating or review about the product (e.g., a “like” or a rating of three out of five stars), the event detection machine may detect a rating or review being entered by the user.

Activity indicators may be aggregated and monitored by the event detection machine, and the activity indicators may each be time stamped (e.g., marked with a date and time that the activity was initiated, performed, or completed). Accordingly, the event detection machine may detect increases and decreases in activity indicators of a particular type (e.g., queries, listings, or transactions) over time. In particular, the event detection machine may detect a burst (e.g., a spike, a surge, or a flood) of activity indicators of the particular type within a particular time period (e.g., a week, a month, a year, or a decade) based on the timestamps of activity indicators received, accessed, or otherwise detected during the particular time. Similarly, the event detection machine may detect a dip (e.g., a lull, a drop, or a drought) in activity indicators of the particular type within a particular time period. For clarity, example embodiments described herein involve detection of events from bursts of activity indicators. However, other example embodiments may use the same or similar methodologies to implement detection of events from dips in activity indicators.

The event detection machine may access time-stamped activity indicators from a database, and from these accessed activity indicators, the event detection machine may determine that a first burst of activity indicators is repetitive of a second burst of activity indicators. For example, such a determination may be based on the first and second bursts each including a keyword that is shared in common between the first and second bursts. In other words, the event detection machine may determine that these bursts of activity indicators is a repeating phenomenon (e.g., a repetitive event), and the repeating phenomenon may be characterized by one or more keywords shared in common among periodic (e.g., repeating) bursts of activity indicators.

For example, activity indicators may indicate that the keywords “black tutu” are heavily represented in queries, sales transactions, and page views within a product catalog annually during the two weeks prior to Halloween, and the event detection machine may determine that a burst of activity indicators with “black tutu” in 2011 is repetitive of a burst of activity indicators with “black tutu” in 2010. Based on such a determination, the event detection machine may generate or modify a data structure (e.g., a table or map) that indicates a time period that encompasses a repetitive event as corresponding to the keyword shared in common between the first and second bursts of activity indicators (e.g., an annual spike in interest in black tutus during the two weeks before Halloween).

In addition, the event detection machine may correlate repetitive events with each other. In particular, these repetitive events may be correlated even where their respective keywords appear to be semantically unrelated. For example, the event detection machine may determine that, every year, a three-week period prior to Halloween also corresponds to a surge in queries, sales transactions, and page views with respect to the keywords “Gothic cape,” which may be semantically unrelated to the phrase “black tutu.” Based on such a determination, the event detection machine may track a further repetitive event (e.g., an annual spike in interest in Gothic capes during the three weeks before Halloween). These repetitive events (e.g., spikes in interest in black tutus and Gothic capes) may be correlated in the data structure and used for merchandising, advertising, recommendations, suggestions, inventory optimization, business planning, user experience enhancements, or any suitable combination thereof.

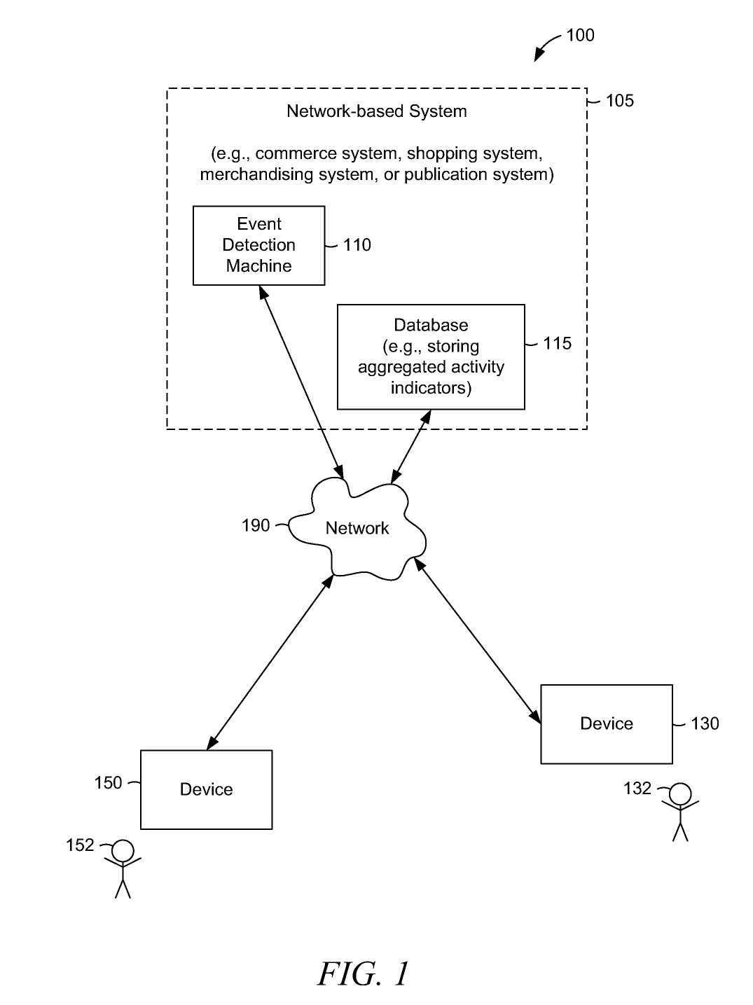

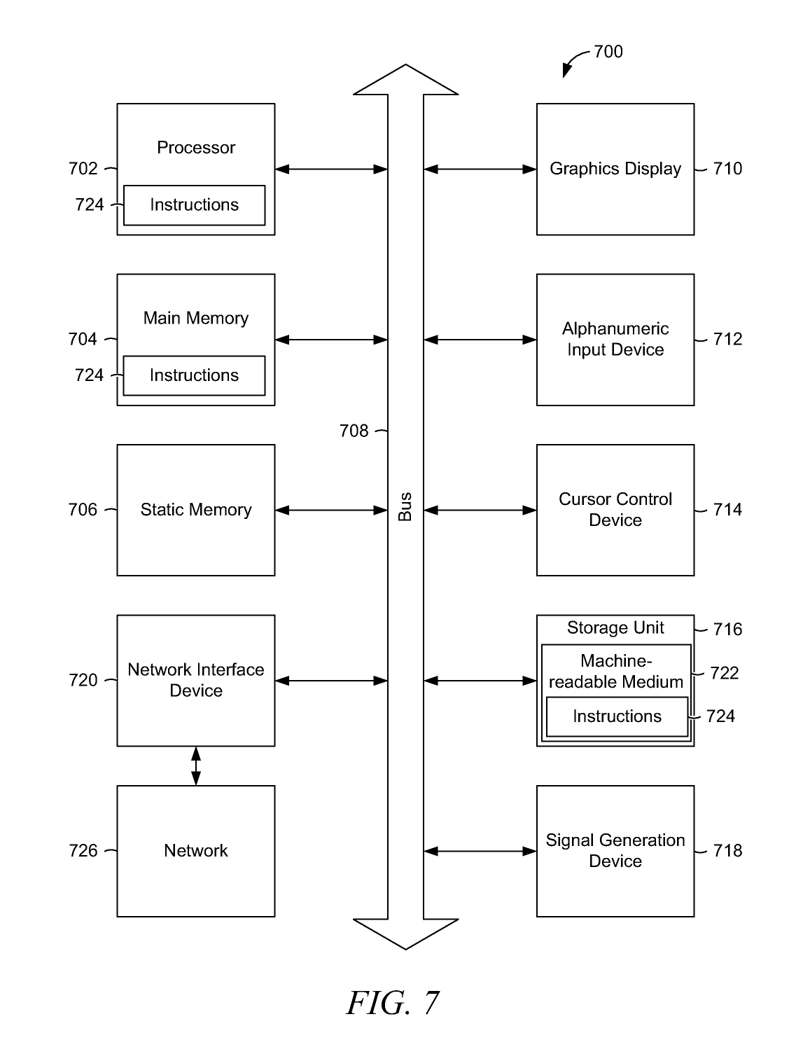

FIG. 1 is a network diagram illustrating a network environment 100 suitable for detection of events from bursts of activity indicators, according to some example embodiments. The network environment 100 includes an event detection machine 110, a database 115, and devices 130 and 150, all communicatively coupled to each other via a network 190. The event detection machine 110, the database 115, and the devices 130 and 150 may each be implemented in a computer system, in whole or in part, as described below with respect to FIG. 7.

As shown in FIG. 1, the event detection machine 110, the database 115, or both, may form all or part of a network-based system 105. The network-based system 105 may be or include a network-based commerce system, a network-based shopping system, a network-based merchandising system, a network-based publication system, a network-based payment system, or any suitable combination thereof. The database 115 may be configured to store activity indicators. In some example embodiments, the database 115 aggregates and stores activity indicators from one or more network-based services provided by the network-based system 105, and the event detection machine 110 may access these activity indicators from the database 115. One or both of the devices 130 and 150 may be used to access (e.g., receive, interface with, or otherwise interact with) one or more network-based services provided by the network-based system 105. Moreover, the event detection machine 110 may provide information (e.g., an advertisement, a suggestion, a message, or a data structure) to one or more of the devices 130 and 150 for presentation thereon (e.g., visual display on a display screen or auditory presentation via a speaker).

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines illustrated in FIG. 1 may be combined into a single machine, and the functions described herein for any single machine may be subdivided among multiple machines.

The network 190 may be any network that enables communication between machines (e.g., the event detection machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

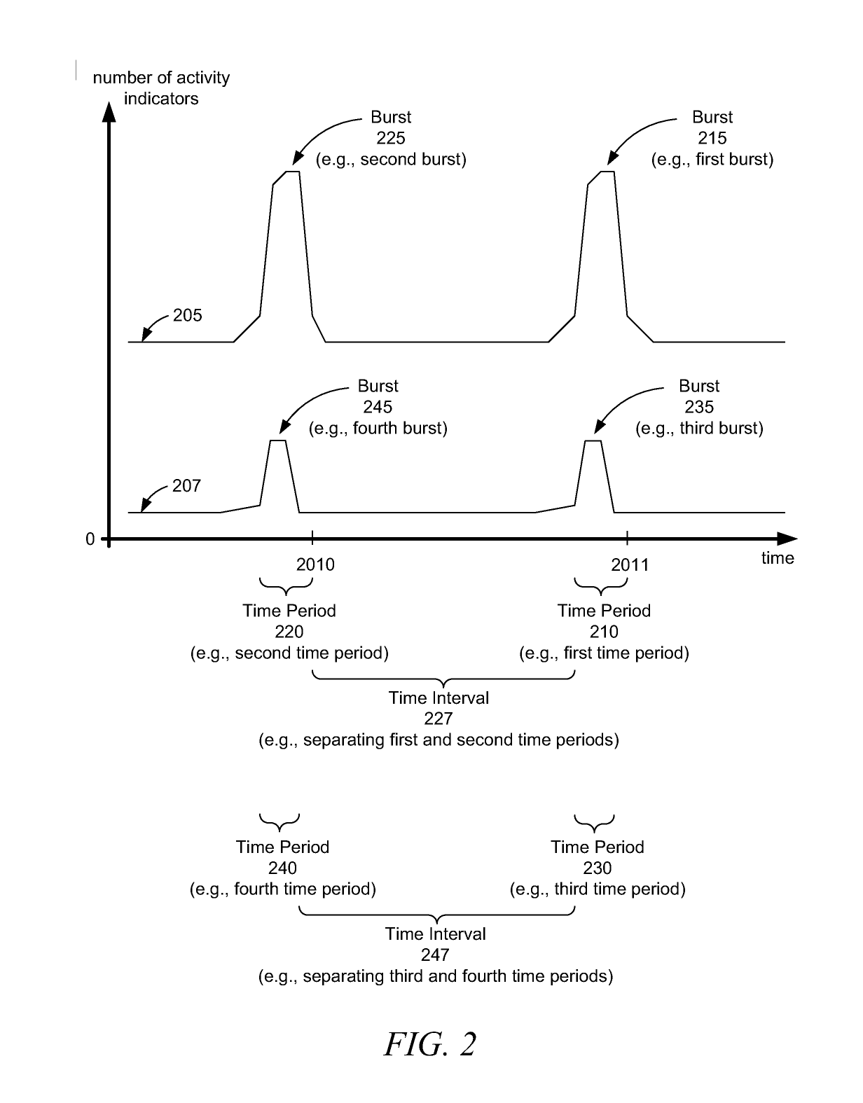

FIG. 2 is a conceptual diagram illustrating numbers of activity indicators detected over time, according to some example embodiments. As noted above, activity indicators may be time-stamped. A line 205 graphically represents the number of activity indicators that include a keyword shared in common (e.g., “tutu”), plotted as a function of time (e.g., years 2009 to 2012). The line 205 indicates a burst 215 of activity indicators (e.g., a first burst) that are time-stamped within a time period 210 (e.g., a first time period). The line 205 also indicates a burst 225 of activity indicators (e.g., a second burst) that are time-stamped within a time period 220 (e.g., a second time period). As shown, a time interval 227 separates the burst 215 from the burst 225. The event detection machine 110 may access the bursts 215 and 225 of activity indicators represented in line 205 and determine that the burst 215 is repetitive of the burst 225. Based on this determination, the event detection machine 110 may generate a data structure (e.g., a table or map) that indicates the time period 210, the time period 220, or both, encompass a repetitive event that corresponds to the keyword (e.g., “tutu”) shared in common by the activity indicators represented by the line 205.

Similarly, a line 207 graphically represents the number of activity indicators that include another keyword shared in common (e.g., “Gothic”), plotted as a function of time. The line 207 indicates a burst 235 of activity indicators (e.g., a third burst) that are time-stamped within a time period 230 (e.g., a third time period). The line 207 also indicates a burst 245 of activity indicators (e.g., a fourth burst) that are time-stamped within a time period 240 (e.g., a fourth time period). As shown, a time interval 247 separates the burst 235 from the burst 245. The event detection machine 110 may access the bursts 235 and 245 of activity indicators represented in line 207 and determine that the burst 235 is repetitive of the bursts 245. Based on this determination, the event detection machine 110 may generate a data structure that indicates the time period 230, the time period 240, or both, encompass another repetitive event (e.g., a further repetitive event), specifically, a repetitive event that corresponds to the keyword (e.g., “Gothic”) shared in common by the activity indicators represented by the line 207.

According to various example embodiments, the time interval 227 may be similar (e.g., within a threshold value of correlation of similarity) to the time interval 247. Based on this similarity, the event detection machine 110 may determine that the repetitive event encompassed by the time period 210, the time period 220, or both, corresponds to (e.g., is correlated with) the repetitive event encompassed by the time period 230, the time period 240, or both. In some example embodiments, this determination is further based on the times at which one or more of the time periods 210, 220, 230, and 240 begin or end. Based on this determination, the event detection machine 110 may generate or modify the data structure to indicate that a repetitive event (e.g., encompassed by the time period 210) is correlated with one or more additional keywords (e.g., “Gothic”) that are shared in common among bursts (e.g., the burst 245) of activity indicators associated with a different repetitive event (e.g., encompassed by the time period 240).

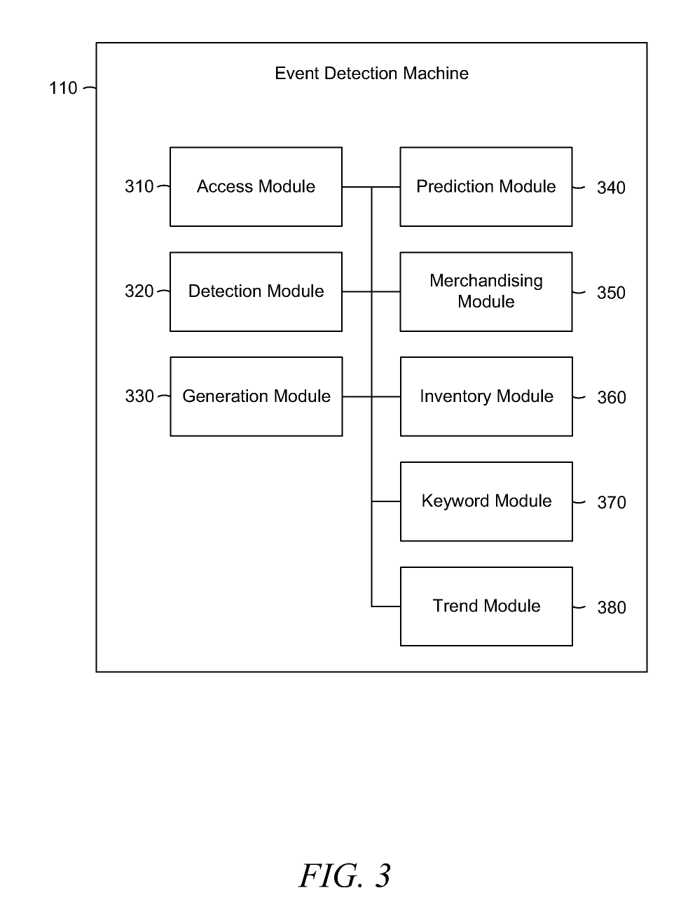

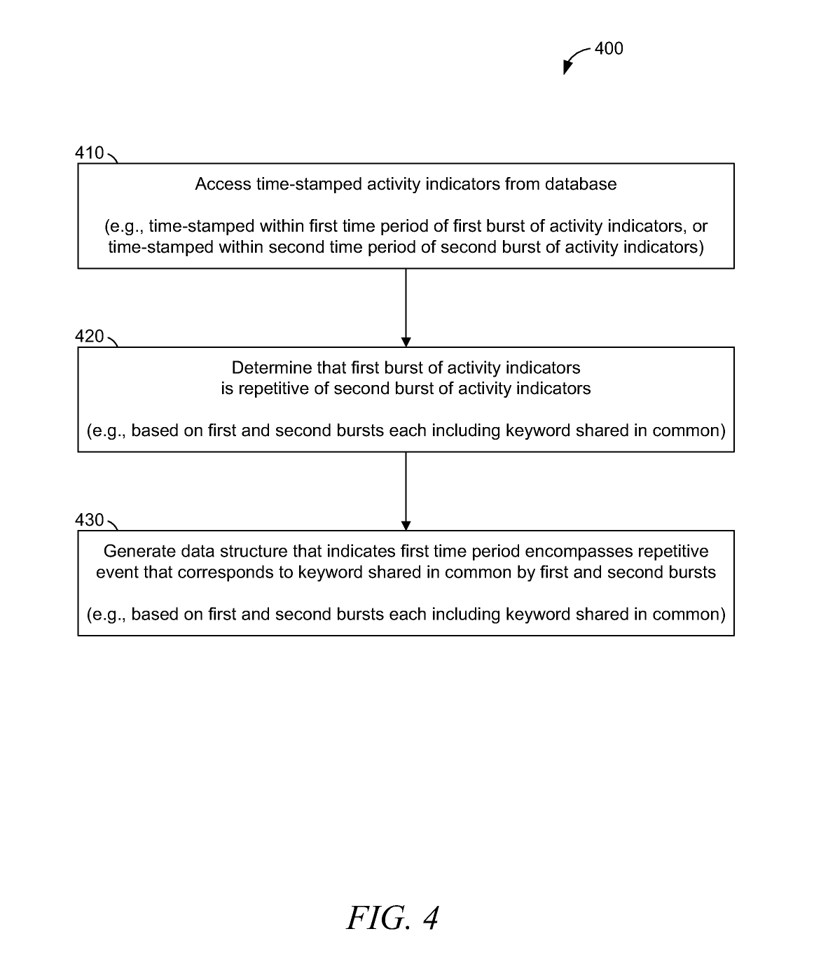

FIG. 3 is a block diagram illustrating components of the event detection machine 110, according to some example embodiments. The event detection machine 110 includes an access module 310, detection module 320, and the generation module 330. The event detection machine 110 may also include a prediction module 340, a merchandising module 350, an inventory module 360, a keyword module 370, a trend module 380, or any suitable combination thereof. As shown in FIG. 3, some or all of the modules in the event detection machine 110 may be configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Further details on the functions of the various modules of the event detection machine 110 are described below with respect to FIG. 4-6.

FIG. 4-6 are flowcharts illustrating operations of the event detection machine 110 in performing a method 400 of detecting events from bursts of activity indicators (e.g., bursts 215 and 225), according to some example embodiments. Operations in the method 400 may be performed by the event detection machine 110 using modules described above with respect to FIG. 3. As shown in FIG. 4, the method 400 includes operations 410, 420, and 430.

In operation 410, the access module 310 accesses activity indicators. The activity indicators may be stored in the database 115, and the access module 310 may accordingly access the activity indicators from the database 115. As noted above, the activity indicators may be time-stamped. Hence, the access module 310 may access activity indicators of which some are time-stamped within the time period 210 (e.g., the first time period) and of which some other activity indicators are time-stamped within the time period 220 (e.g., the second time period). As noted above, the time period 210 and the time period 220 may be separated by the time interval 227.

In operation 420, the detection module 320 determines that the burst 215 of activity indicators (e.g., the first burst) is repetitive of the burst 225 of activity indicators (e.g., the second burst). This determination may be made based on the activity indicators accessed in operation 410. As noted above with respect to FIG. 2, the activity indicators in the bursts 215 and 225 may each include a keyword shared in common (e.g., “tutu”).

In operation 430, the generation module 330 generates a data structure (e.g., a table, a map, a file, or a database record within the database 115) that indicates that the time period 210 (e.g., the first time period) encompasses (e.g., includes or contains) a repetitive event (e.g., Halloween Day or Halloween shopping season) that corresponds to the keyword shared in common (e.g., “tutu”) by the bursts 215 and 225 (e.g., the first and second bursts) of activity indicators. In some example embodiments, the generation module 330 modifies an existing data structure to indicate that the time period 210 encompasses the repetitive event that corresponds to the keyword.

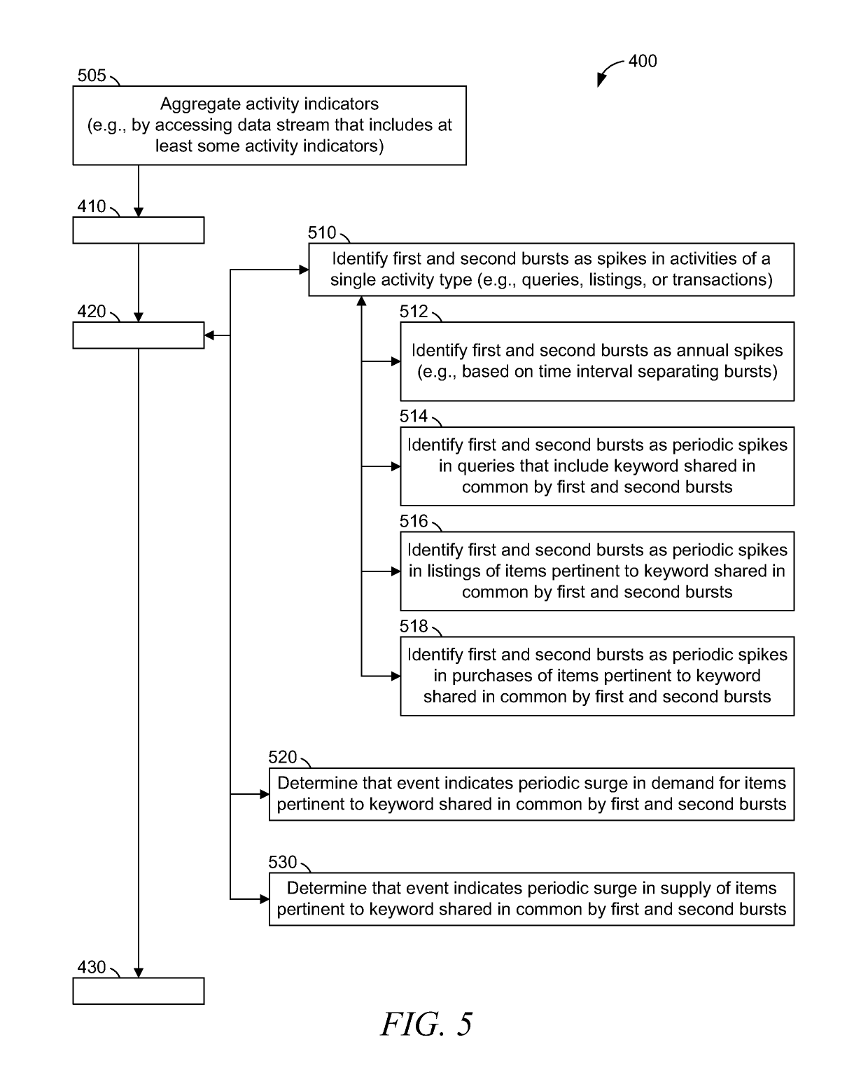

As shown in FIG. 5, the method 400 may include one or more of operations 505, 510, 512, 514, 516, 518, 520, and 530. In operation 505, the access module 310 aggregates the activity indicators discussed above with respect to operation 410. For example, the access module 310 may monitor one or more services provided by the network-based system 105 (e.g., by accessing a datastream that includes at least some of the activity indicators represented in FIG. 2 by the line 205), detect some or all of the activity indicators, and store the detected activity indicators in the database 115 (e.g., for access during performance of operation 410).

One or more of operations 510, 520, and 530 may be performed as part (e.g., a precursor task, a subroutine, or a portion) of operation 420, in which the detection module 320 determines that the burst 215 (e.g., the first burst), which corresponds to the time period 210 (e.g., the first time period), is repetitive of the burst 225 (e.g., the second burst), which corresponds to the time period 220 (e.g., the second time period).

In operation 510, the detection module 320 identifies the bursts 215 and 225 as spikes in activities of a single activity type. In some example embodiments, the single activity type represents queries (e.g., for search results, listings of products, product information, or any suitable combination thereof). In certain example embodiments, the single activity type represents listings of items or products for sale (e.g., auction listings, classified advertisements, pages from an online product catalog, or any suitable combination thereof). In various example embodiments, the single activity type represents transactions that involve an item or product (e.g., sales, purchases, offers, bids, or any suitable combination thereof).

In operation 520, the detection module 320 determines that the repetitive event indicates a periodic (e.g., monthly, quarterly, or annual) surge in demand for items or products pertinent to the keyword shared in common (e.g., “tutu”) by the bursts 215 and 225 of activity indicators. For example, the detection module 320 may make this determination based on the bursts 215 and 225 containing activity indicators that represent queries pertinent to the keyword, bids on items or products pertinent to the keyword, purchases of items or products pertinent to the keyword, sales of items or products pertinent to the keyword, or any suitable combination thereof. Following the example where the keyword is “tutu,” items pertinent to the keyword may include tutus, ballet costumes, ballet dresses, ballet shoes, leotards, and tights.

In operation 530, the detection module 320 determines that the repetitive event indicates a periodic surge in a supply of items or products pertinent to the keyword shared in common (e.g., “tutu”) by the bursts 215 and 225 of activity indicators. For example, the detection module 320 may make this determination based on the bursts 215 and 225 containing activity indicators that represent advertisements pertinent to the keyword, listings of items or products pertinent to the keyword, updates to inventories that include items or products pertinent to the keyword, news regarding manufacture of items or products pertinent to the keyword, or any suitable combination thereof.

One or more of operations 512, 514, 516, and 518 may be performed as part of operation 510, in which the detection module 320 identifies spikes in activities of a single activity type (e.g., queries, listings, or transactions). In operation 512, the detection module 320 identifies the bursts 215 and 225 of activity indicators as annual spikes of the single activity type. This identification may be performed based on the time interval 227 by which the burst 215 (e.g., the first burst) is separated from the burst 225 (e.g., the second burst).

In operation 514, the detection module 320 identifies the bursts 215 and 225 of activity indicators as periodic (e.g., weekly, monthly, quarterly, yearly, or biannual) spikes in queries that include the keyword shared in common (e.g., “tutu”) by the bursts 215 and 225 (e.g., the first and second bursts). This identification may be performed based on the time interval 227.

In operation 516, the detection module 320 identifies the bursts 215 and 225 of activity indicators as periodic spikes in listings (e.g., of products or items) that include the keyword shared in common (e.g., “tutu”) by the bursts 215 and 225 (e.g., the first and second bursts). This identification may be performed based on the time interval 227.

In operation 518, the detection module 320 identifies the bursts 215 and 225 of activity indicators as periodic spikes in purchases of items or products pertinent to the keyword shared in common (e.g., “tutu”) by the bursts 215 and 225 (e.g., the first and second bursts). For example, the items or products may have descriptions that include the keyword (e.g., in the title of the description, or in the first paragraph of the description). This identification may be performed based on the time interval 227.

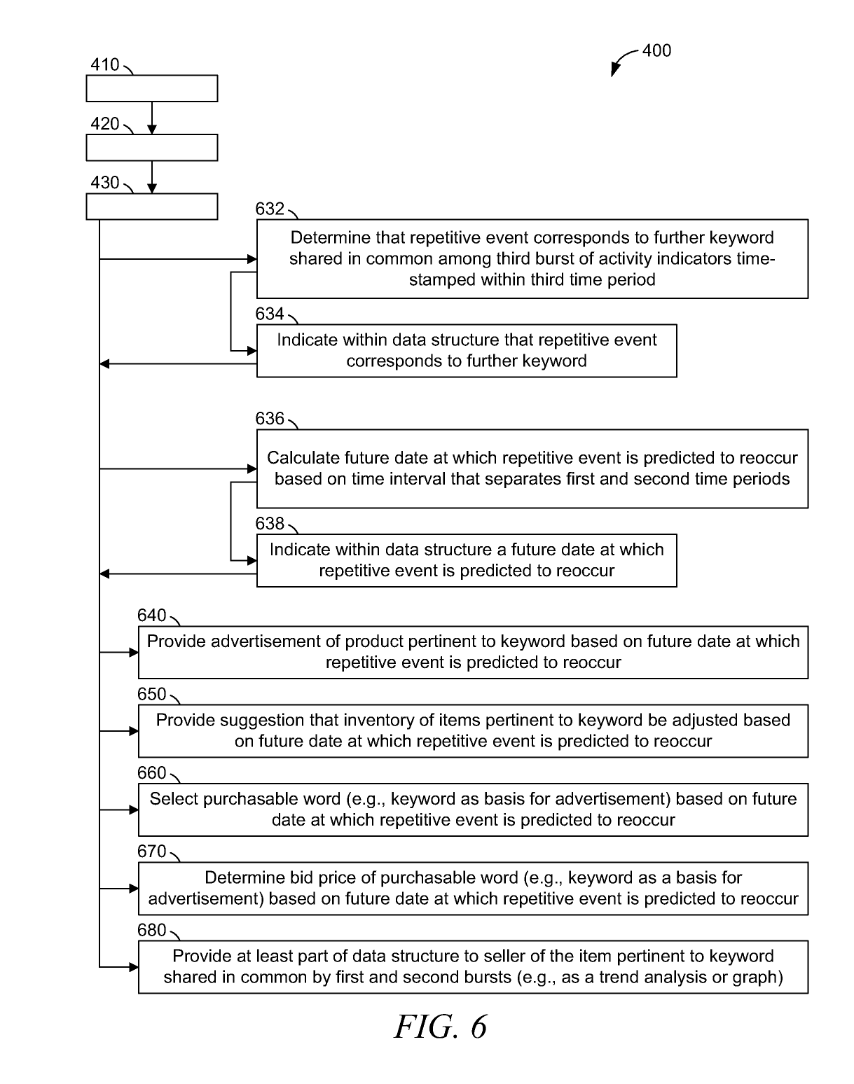

As shown in FIG. 6, the method 400 may include one or more of operations 632, 634, 636, 638, 640, 650, 660, 670, and 680. One or more of operations 632-638 may be performed after operation 430, in which the generation module 330 generates the data structure that indicates that the time period 210 encompasses the repetitive event that corresponds to the keyword shared in common (e.g., “tutu”) by the bursts 215 and 225 (e.g., the first and second bursts) of activity indicators. In some example embodiments, one or more of operations 632-638 may be performed after operation 420, in which the detection module 320 determines that the burst 215 (e.g., the first burst) is repetitive of the burst 225 (e.g., the second burst).

In operation 632, the detection module 320 determines that the repetitive event discussed above with respect to operation 430 corresponds to another keyword (e.g., a further keyword) shared in common among the burst 235 (e.g., the third burst) of activity indicators. As noted above, the activity indicators in the burst 235 may be time stamped within the time period 230 (e.g., the third time period). In some example embodiments, the burst 245 may be used instead of the burst 235 (e.g., as the third burst).

In operation 634, the generation module 330 indicates within the data structure discussed above with respect to operation 430 that the repetitive event corresponds to the keyword (e.g., the further keyword, such as “Gothic”) shared in common among the burst 235 (e.g., the third burst) of activity indicators. In example embodiments that use the burst 245 instead of the burst 235 in operation 632, the generation module 330 in operation 634 indicates within the data structure that the repetitive event corresponds to the keyword shared in common (e.g., “Gothic”) among the burst 245 of activity indicators.

In operation 636, the prediction module 340 calculates a future date (e.g., a month, quarter, or year from the time period 210) at which the repetitive event discussed above with respect to operation 430 is predicted to reoccur. This calculation may be based on the time interval 227 by which the time period 210 (e.g., the first time period) is separated from the time period 220 (e.g., the second time period).

In operation 638, the generation module 330 indicates within the data structure (e.g., stored in the database 115) the future date calculated in operation 636. For example, the generation module 330 may modify, edit, or update the data structure within the database 115. In some example embodiments, the generation module 330 replaces the data structure with a newly generated (e.g., regenerated) data structure.

In operation 640, the merchandising module 350 provides an advertisement of a product (e.g., an advertisement depicting or referencing one or more items that are instances or specimens of the product) pertinent to the keyword (e.g., “tutu”). The advertisement of the product may be provided based on the future date calculated in operation 636. For example, the merchandising module 350 may provide the advertisement a month prior to the calculated future date, a week prior to the calculated future date, or on the calculated future date. In some example embodiments, the merchandising module 350 provides the advertisement to the device 130 for presentation to the user 132 (e.g., a potential or actual buyer of the product).

In operation 650, the inventory module 360 provides a suggestion that an inventory of products or items (e.g., instances or specimens of a product) pertinent to the keyword (e.g., “tutu”) be adjusted (e.g., increased or decreased). The suggestion may be provided based on the future date calculated in operation 636. For example, the inventory module 360 may provide a suggestion a quarter prior to the calculated future date, a month prior to the calculated future date, or a week prior to the calculated future date. In some example embodiments, the inventory module 360 provides the suggestion to the device 150 for presentation to the user 152 (e.g., a potential or actual seller of an item or product).

In operation 660, the keyword module 370 selects a word that is purchasable as a basis of an advertisement (e.g., one or more Google® Adwords®). The word may be selected based on the future date calculated in operation 636. For example, the keyword module 370 may select the word “tutu” for purchasing as a basis for advertising, and the selecting of the word “tutu” or the purchasing of the word “tutu” may be timed to occur a month prior to the calculated future date, a week prior to the calculated future date, or on the calculated future date. In some example embodiments, the keyword module 370 performs the selection, purchase, or both, of the word, on behalf of the network-based system 105. This selection or purchase of the word may be performed by communicating with a vendor system (e.g., a network-based advertising system) that offers the word for sale as a basis for advertising.

In operation 670, the keyword module 370 determines a bid price of a word purchasable as a basis of an advertisement (e.g., the purchasable word discussed above with respect to operation 660). The bid price may be determined based on the future date calculated in operation 636. For example, the keyword module 370 may determine that the bid price for the word “tutu” is $5 per thousand impressions or $2 per click during the month prior to the calculated future date, compared to just $2 per thousand impressions or $1 per click during the month after the calculated future date. In some example embodiments, the keyword module 370 submits a bid for the word, at the bid price, on behalf of the network-based system 105. This submission of the bid may be performed by communicating with a vendor system (e.g., Google®) that offers the word for sale as a basis for advertising.

In operation 680, the trend module 380 provides all or part of the data structure generated in operation 430 to a seller of a product or item (e.g., as instance of the product) pertinent to the keyword shared in common (e.g., “tutu”) by the bursts 215 and 225 (e.g., the first and second bursts) of activity indicators. For example, the trend module 380 may provide all or part of the data structure from the database 115 to the device 150 for presentation to the user 152 (e.g., the seller of the product or item). Some example embodiments, the data structure may be provided as part of a message, document, or report that indicates a trend in a supply of the product or item or that indicates a trend in demand for the product or item.

According to various example embodiments, one or more of the methodologies described herein may facilitate detection of events (e.g., identification of events) from bursts or dips in activity indicators that include keywords pertinent to those events. Moreover, one or more of the methodologies described herein may facilitate prediction of one or more future dates at which a repetitive event may reoccur. Hence, one or more the methodologies described herein may facilitate merchandising (e.g., advertising) of products or items pertinent to the repetitive event, adjustments to an inventory of products or items pertinent to the repetitive event, selection of a word purchasable for advertising related to the repetitive event, determination of a price for such a word, provision of trend information regarding the repetitive event, or any suitable combination thereof.

When these effects are considered in aggregate, one or more of the methodologies described herein may obviate a need for certain efforts or resources that otherwise would be involved in detection of events from activity indicators. Efforts expended by a user in the role of a buyer of a product or item, in the role of a seller of a product or item, or in the role of an administrator of a network-based system may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 7 is a block diagram illustrating components of a machine 700, according to some example embodiments, able to read instructions from a machine-readable medium (e.g., a machine-readable storage medium) and perform any one or more of the methodologies discussed herein, in whole or in part. Specifically, FIG. 7 shows a diagrammatic representation of the machine 700 in the example form of a computer system and within which instructions 724 (e.g., software, a program, an application, an applet, an app, or other executable code) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 (e.g., network 190) via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
an access module configured to access activity indicators of which some are time-stamped within a first time period and some others are time-stamped within a second time period that is separated from the first time period by a time interval;
a detection module configured to determine that a first burst of activity indicators time-stamped within the first time period is repetitive of a second burst of activity indicators time-stamped within the second time period separated from the first time period based on the accessed activity indicators,
the first and second bursts of activity indicators each including a keyword shared in common; and
a processor configured by a generation module to generate a data structure that indicates the first time period encompasses a repetitive event that corresponds to the keyword shared in common by the first and second bursts of activity indicators.

2. The system of claim 1 further comprising:
a prediction module configured to calculate a future date at which the repetitive event is predicted to reoccur based on the time interval by which the first time period is separated from the second time period; and wherein
the generation module is configured to indicate within the data structure the future date at which the repetitive event that corresponds to the keyword is predicted to reoccur.

3. A method comprising:
accessing activity indicators of which some are time-stamped within a first time period and some others are time-stamped within a second time period that is separated from the first time period by a time interval;
determining that a first burst of activity indicators time-stamped within the first time period is repetitive of a second burst of activity indicators time-stamped within the second time period separated from the first time period based on the accessed activity indicators,
the first and second bursts of activity indicators each including a keyword shared in common; and
generating a data structure that indicates the first time period encompasses a repetitive event that corresponds to the keyword shared in common by the first and second bursts of activity indicators,
the generating of the data structure being performed by a processor of a machine.

4. The method of claim 3 further comprising:
aggregating the activity indicators by accessing a datastream that includes at least some of the activity indicators of which some are time-stamped within the first time period and some others are time-stamped within the second time period.

5. The method of claim 3, wherein:
the determining that the first burst of activity indicators is repetitive of the second burst of activity indicators includes identifying the first and second bursts as spikes in activities of a single activity type.

6. The method of claim 5, wherein:
the identifying of the first and second bursts identifies the first and second bursts as annual spikes of the single activity type based on the time interval by which the first time period is separated from the second time period.

7. The method of claim 5, wherein:
the identifying of the first and second bursts identifies the first and second bursts as periodic spikes in queries that include the keyword shared in common by the first and second bursts of activity indicators.

8. The method of claim 5, wherein:
the identifying of the first and second bursts identifies the first and second bursts as periodic spikes in listings of items pertinent to the keyword shared in common by the first and second bursts of activity indicators.

9. The method of claim 5, wherein:
the identifying of the first and second bursts identifies the first and second bursts as periodic spikes in purchases of items pertinent to the keyword shared in common by the first and second bursts of activity indicators.

10. The method of claim 3 further comprising:
determining that the repetitive event corresponds to a further keyword shared in common among a third burst of activity indicators time-stamped within a third time period; and
indicating within the data structure that the repetitive event corresponds to the further keyword.

11. The method of claim 3 further comprising:
calculating a future date at which the repetitive event is predicted to reoccur based on the time interval by which the first time period is separated from the second time period; and
indicating within the data structure the future date at which the repetitive event that corresponds to the keyword is predicted to reoccur.

12. The method of claim 3 further comprising:
providing an advertisement of a product pertinent to the keyword based on a future date at which the repetitive event that corresponds to the keyword is predicted to reoccur.

13. The method of claim 3 further comprising:
providing a suggestion that an inventory of items pertinent to the keyword be adjusted based on a future date at which the repetitive event that corresponds to the keyword is predicted to reoccur.

14. The method of claim 3 further comprising:
selecting a word purchasable as a basis of an advertisement based on a future date at which the repetitive event that corresponds to the keyword is predicted to reoccur.

15. The method of claim 3 further comprising:
determining a bid price of a word purchasable as a basis of an advertisement based on a future date at which the repetitive event that corresponds to the keyword is predicted to reoccur.

16. The method of claim 3 further comprising:
providing at least part of the generated data structure that indicates the first time period encompasses the repetitive event to a seller of an item pertinent to the keyword shared in common by the first and second bursts of activity indicators.

17. The method of claim 3, wherein:
the repetitive event indicates a periodic surge in demand for items pertinent to the keyword shared in common by the first and second bursts of activity indicators.

18. The method of claim 3, wherein:
the repetitive event indicates a periodic surge in a supply of items pertinent to the keyword shared in common by the first and second bursts of activity indicators.

19. A non-transitory machine-readable storage medium comprising instructions that, when executed by one or more processors of a machine, cause the machine to perform operations comprising:
accessing activity indicators of which some are time-stamped within a first time period and some others are time-stamped within a second time period that is separated from the first time period by a time interval;
determining that a first burst of activity indicators time-stamped within the first time period is repetitive of a second burst of activity indicators time-stamped within the second time period separated from the first time period based on the accessed activity indicators,
the first and second bursts of activity indicators each including a keyword shared in common; and
generating a data structure that indicates the first time period encompasses a repetitive event that corresponds to the keyword shared in common by the first and second bursts of activity indicators,
the generating of the data structure being performed by the one or more processors of the machine.

20. The non-transitory machine-readable storage medium of claim 19, wherein the operations further comprise:
calculating a future date at which the repetitive event is predicted to reoccur based on the time interval by which the first time period is separated from the second time period; and
indicating within the data structure the future date at which the repetitive event that corresponds to the keyword is predicted to reoccur.
